(19) United States
(12) Patent Application Publication
(10) Pub. No.: US 2020/0360839 A1
(43) Pub. Date: Nov. 19, 2020

(54) VENTING DEVICE FOR VENTING A MOTOR VEHICLE TANK

(71) Applicant: MAGNA STEYR Fuel Systems GesmbH, Sinabelkirchen (AT)

(72) Inventors: Patrick Michael WIEDNER, Hartberg (AT); Dominik STEINMANN, Stubenberg (AT); Karl-Heinz KULMER, Gleisdorf (AT)

(21) Appl. No.: 16/869,702

(22) Filed: May 8, 2020

(30) Foreign Application Priority Data
May 15, 2019 (EP) 19174649.4

(51) Int. Cl. B01D 19/00; B60K 15/035

(52) U.S. Cl. CPC B01D 19/0042; B60K 15/035; B01D 19/0094

(57) ABSTRACT

A venting device for venting a motor vehicle tank that includes a filling pipe, a venting line, a degassing line, and a connection nipple. The venting line is for fluidic connection at a first venting line end to the motor vehicle tank, and at a second venting line end opposite the first venting line end to the filling pipe via a venting inlet. The degassing line is for fluidic connection at a first degassing line end to the filling pipe via a degassing outlet, and at a second degassing line end opposite the first degassing line end to a liquid separator. The connection nipple is arranged on the filling pipe upon which the venting inlet and the degassing outlet are constructed.

### CROSS-REFERENCE TO RELATED APPLICATIONS

The present application claims priority 35 U.S.C. § 119 to European Patent Publication No. EP 19174649.4 (filed on May 15, 2019), which is hereby incorporated by reference in its entirety.

### TECHNICAL FIELD

Embodiments relate to a venting device for venting a motor vehicle tank.

### BACKGROUND

It is known to vent motor vehicle tanks, that is to say, tanks in motor vehicles, in particular, tanks for the fuel for driving the motor vehicle, such as petrol or diesel fuel, during operation of the motor vehicle via an operational venting action. The operational venting action is generally carried out at one or more highest points of the motor vehicle tank. The discharged gas can be directed into a fuel vapor filter, in particular, an activated carbon filter, in order to discharge as few hydrocarbons as possible to the environment. For refueling the motor vehicle tank, an individual refueling venting system can be provided, wherein the gas discharged during the refueling venting is also directed into the activated carbon filter.

In order to prevent damage to the activated carbon filter, it is known to separate the fuel vapor which flows into the venting lines via a liquid separator so that liquid is separated and can flow back into the tank again and only gas reaches the activated carbon filter. Such liquid separators may be arranged in the venting lines in the form of individual intermediate containers. In recent times, it is also known to construct liquid separators directly in a connection nipple of the filling pipe so that separated liquid can reach the filling pipe directly and can flow away via the filling pipe. Such separation nipples require only a small amount of structural space and the separated liquid can readily be discharged.

EP 1955888 A2 discloses a fluid vapor separator for the fuel system of a vehicle, wherein the fluid vapor separator comprises a body having an inlet which can be connected to a venting system of a fuel tank and having a vapor outlet which can be connected to a fuel vapor processing device, and a condensation chamber for condensing fuel droplets, wherein the condensation chamber is connected in flow terms to the inlet and outlet, a droplet separator which comprises a partition wall is arranged in the condensation chamber and the condensation chamber extends on a filling connection piece of the fuel system.

During travel operation, and during so-called instantaneous venting actions, for example, for instantaneously reducing the pressure after actuating a tank cap unlocking unit of a hybrid vehicle, there may be produced in the venting system high gas volume flows which may also have a high saturation of liquid fuel.

Known separation nipples on the filling pipe can scarcely cope with such relatively high gas volume flows, particularly as a result of the low operating volume of such separators. However, an excessively small degree of separation may bring about an increased loading or even destruction of the fuel vapor filter, in particular, the activated carbon filter.

Although conventional liquid separators which are separate from the filling pipe have larger operating volumes, the supply and discharge of the different liquids is more complex. If volume flows from the venting system of the motor vehicle tank further have to be guided by the filling pipe, this is usually carried out via individual connection nipples, for example, a connection nipple for introducing the gas and at a different location on the filling pipe an additional connection nipple for discharging the gas. Such solutions require many components and are cost-intensive.

### SUMMARY

Embodiments relate to a venting device for venting a motor vehicle tank which also functions reliably at high gas volume flows, but has few components and low production costs.

In accordance with embodiments, a venting device for venting a motor vehicle tank may comprise at least one of: a filling pipe; a venting line for fluidic connection at a first venting line end to the motor vehicle tank, and at a second venting line end opposite the first venting line end to the filling pipe via a venting inlet; and a degassing line for fluidic connection, via a degassing outlet, at a first degassing line end to the filling pipe and at a second degassing line end opposite the first degassing line end to a liquid separator, wherein the venting inlet and the degassing outlet are constructed on a common connection nipple of the filling pipe.

In accordance with embodiments, the venting of a motor vehicle tank is carried out via a venting line, in particular, an operational venting line. The separation of liquid contained in the venting line is carried out in a liquid separator which is separate, therefore apart, from the filling pipe. The gas volume flow is directed into a filling pipe of the motor vehicle tank upstream of the liquid separator via a venting inlet, and is removed from the filling pipe again via a degassing outlet before it reaches the liquid separator.

In accordance with embodiments, a common connection nipple is used in order to produce the venting inlet and the degassing outlet from the filling pipe. In spite of a high separation capacity, by using a liquid separator which is separate from the filling pipe and which has a correspondingly great volume, components and production costs are thereby saved.

In accordance with embodiments, a second venting line, in particular, a refueling venting line, connects the motor vehicle tank directly to the liquid separator in a fluid-conducting manner. The liquid separator can therefore be used both for operational venting and for refueling venting.

In accordance with embodiments, a second degassing line connects the liquid separator to the fuel vapor filter, in particular an activated carbon filter, in a fluid-conducting manner.

In accordance with embodiments, a valve is arranged in the filling pipe at the degassing outlet so that, when a filling nozzle is introduced into the filling pipe, the valve is moved by the filling nozzle in a closing direction and consequently the degassing outlet is reduced or closed while refueling the motor vehicle tank. Vapor which is introduced through the venting inlet during refueling therefore flows away completely, or, for example, except for a predefined amount, simply through the filling pipe.

In accordance with embodiments, the venting inlet is preferably located at the top of the filling pipe in the installation position. The degassing outlet is particularly preferably also located at the top of the filling pipe in the installation position.

The terms “top” and “bottom” relate in the context of this disclosure to the direction of gravitational force so that, for example, liquid falls from the “top” to the “bottom.” Therefore, vapor can flow or fall from the venting line into the filling pipe through the upper venting inlet. A liquid portion of the vapor can flow away along the bottom of the filling pipe while a gaseous portion can reach the upper degassing outlet and can be discharged at that location.

In accordance with embodiments, the venting device comprises a curvilinear guiding member which is arranged in the filling pipe and which is arranged and formed in such a manner that vapor which is introduced through the venting inlet into the filling pipe is guided along the circumference of the filling pipe between the inner wall of the filling pipe and the curvilinear guiding member so that a gaseous portion of the incoming vapor is discharged through the degassing outlet and a liquid portion of the incoming vapor flows away through the filling pipe.

A gas flow is thereby directed to the filling pipe out of the venting line, in particular, the operational venting line, in order to separate the contained liquid and a separation, in addition to the separation at the liquid separator, is not carried out in a connection nipple on the filling pipe but instead in the filling pipe itself. The greater volume of the filling pipe is therefore used as an operating volume for the separation. To this end, the gas volume flow is guided via the venting line as far as the venting inlet on the filling pipe which is constructed at the top in the installation position so that the fuel vapor admixture can fall into the filling pipe.

In accordance with embodiments, movement of the vapor is guided by the curvilinear guiding member, e.g., a component with a curvilinear cross-section. In that way, vapor flows circumferentially, substantially in a circular-arc-like manner, through the cross-section of the filling pipe, in particular filling head. Consequently, only the gaseous portion of the vapor rises. In so doing, the gaseous portion of the vapor is to flow via the degassing outlet arranged at the top in the installation position, e.g., an additional opening, and onwards via the degassing line in order to be introduced in the direction of the liquid separator and preferably of the fuel vapor filter, in particular the activated carbon filter. The liquid fuel does not rise along the flow path which is predetermined by the curvilinear guiding member as far as the degassing outlet and therefore runs off via the filling pipe, in the direction towards the motor vehicle tank.

In accordance with embodiments, ribs are constructed on an outer wall of the curvilinear guiding member facing the inner wall of the filling pipe to separate liquid. The ribs may be constructed only on a portion of the curvilinear guiding member, in particular, only on a first half of the curvilinear guiding member which downwardly guides the vapor introduced.

In accordance with embodiments, the cross-section of the curvilinear guiding member is preferably constructed in a substantially U-shaped manner or an O-shaped manner.

In accordance with embodiments, the curvilinear guiding member may be configured in several pieces.

In accordance with embodiments, the curvilinear guiding member is preferably constructed on the common connection nipple. In particular, the curvilinear guiding member may be fixed to the connection nipple or the curvilinear guiding member is constructed integrally with the connection nipple.

### DRAWINGS

Embodiments will be illustrated by way of example in the drawings and explained in the description hereinbelow.

FIG. 1 illustrates a three-dimensional view of a venting device, in accordance with embodiments.

FIG. 2 illustrates a partial view of the filling pipe of the venting device of FIG. 1 in a region of the connection nipple.

FIG. 3 illustrates a cross-sectional view along section A-A of FIG. 2.

### DESCRIPTION

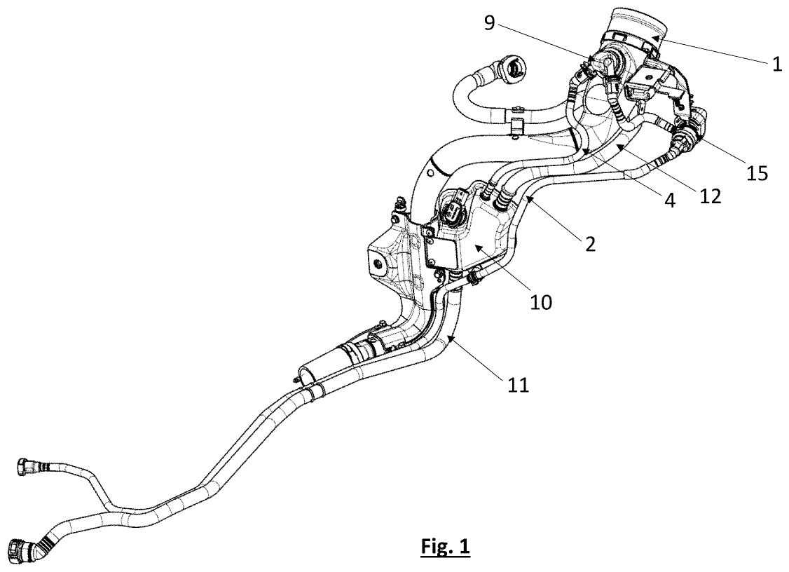

FIG. 1 illustrates a venting device for venting a motor vehicle tank, in particular, a fuel tank, in accordance with embodiments.

The venting device comprises a filling pipe 1, a venting line 2, such as, for example, an operational venting line to be fluidically connected, via a connection nipple 9, at a first venting line end to the motor vehicle tank (See, FIG. 1, lower end of the venting line 2), and at a second venting line end opposite the first venting line end, to the filling pipe 1 downstream of a valve unit 15, at a venting inlet 3 illustrated in FIG. 3.

The venting device further comprises a degassing line 4, as a recirculation line, which is fluidically connected to the filling pipe 1 at a first degassing line end via the connection nipple 9, at a degassing outlet 5 which is illustrated in FIG. 3, and at a second degassing line end opposite the first end to a liquid separator 10 (a so-called “liquid trap”). The venting inlet 3 and the degassing outlet 5 are constructed on the common connection nipple 9 on the filling pipe 1.

The venting inlet 3 is located at a top region of the filling pipe in the installation position in order that vapor can fall, by gravity, through the venting inlet 3 into the filling pipe 1. The degassing outlet 5 is also located at the top region of the filling pipe 1 in the installation position, at least not near the bottom of the filling pipe 1, so that only gas reaches the degassing outlet 5, but no liquid fuel.

A second degassing line 12 connects the liquid separator 10 to a fuel vapor filter, in particular, an activated carbon filter. In FIG. 1 (at the top, on the left beside the connection nipple 9), to this end only the end of the second degassing line 12 intended to be connected to the fuel vapor filter is illustrated, but not the fuel vapor filter itself.

A second venting line 11, that is to say, a refueling venting line, which has a greater diameter than the venting line 2, connects the motor vehicle tank directly to the liquid separator 10.

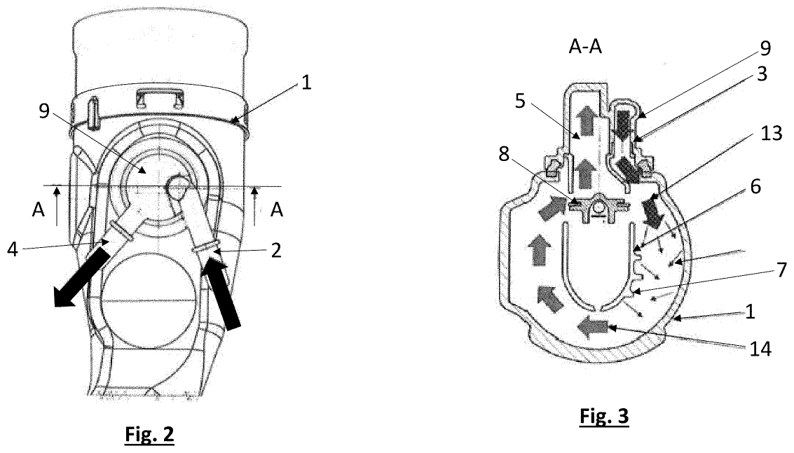

The connection nipple 9 is illustrated in greater detail in FIG. 2. The section A-A depicted in FIG. 2 is illustrated in FIG. 3.

A curvilinear guiding member 6 is arranged and formed in the filling pipe 1 so that a vapor which is introduced through the venting inlet 3 into the filling pipe 1, the incoming fuel/gas admixture 13 which is indicated via arrows, is guided between the inner wall of the filling pipe 1 and the curvilinear guiding member 6 along the circumference of the filling pipe 1 so that a gaseous portion of the incoming vapor, again depicted by arrows as gas 14, is discharged through the degassing outlet 5 and a liquid portion of the incoming vapor flows away through the filling pipe 1 (in FIG. 3, in the direction towards the viewer).

The curvilinear guiding member 6 is constructed, for example, in the manner of a cylinder segment or cone segment or in a funnel-like manner.

In order to separate the liquid, a plurality of ribs 7 are partially constructed to extend from or on an outer wall of the curvilinear guiding member 6 facing the inner wall of the filling pipe 1.

The curvilinear guiding member 6 is substantially constructed as a profile with a U-shaped cross-section or constructed with an O-shaped cross-section.

A valve 8 is arranged in the filling pipe 1 at the degassing outlet 5. The valve 8 is supported in an axially displaceable manner. When a filler nozzle is introduced into the filling pipe 1, the valve 8 is moved by the filler nozzle in a closing direction and consequently the degassing outlet 5 is reduced or closed during refueling of the motor vehicle tank.

The curvilinear guiding member 6 is fixed at the upper ends thereof, the ends of the legs of the U-shape, to the common connection nipple 9. The curvilinear guiding member 6 can also form the valve seat for the valve 8.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Filling pipe
2 Venting line
3 Venting inlet
4 Degassing line
5 Degassing outlet
6 Curvilinear guiding member
7 Ribs
8 Valve
9 Connection nipple
10 Liquid separator
11 Second venting line
12 Second degassing line
13 Fuel/gas admixture
14 Gas
15 Valve unit

What is claimed is:

1. A venting device for venting a motor vehicle tank, the venting device comprising:
a filling pipe;
a venting line for fluidic connection at a first venting line end to the motor vehicle tank, and at a second venting line end opposite the first venting line end to the filling pipe via a venting inlet;
a degassing line for fluidic connection at a first degassing line end to the filling pipe via a degassing outlet, and at a second degassing line end opposite the first degassing line end to a liquid separator; and
a connection nipple arranged on the filling pipe upon which the venting inlet and the degassing outlet are constructed.

2. The venting device of claim 1, further comprising a second venting line to fluidically connect the motor vehicle tank directly to the liquid separator.

3. The venting device of claim 1, further comprising a second degassing line to fluidically connect the liquid separator to a fuel vapor filter.

4. The venting device of claim 1, further comprising:
a second venting line to fluidically connect the motor vehicle tank directly to the liquid separator; and
a second degassing line to fluidically connect the liquid separator to a fuel vapor filter.

5. The venting device of claim 1, further comprising a valve arranged in the filling pipe at the degassing outlet, the valve being moveable in a closing direction in response to introduction of a filling nozzle into the filling pipe, to thereby reduce or close the degassing outlet during refueling of the motor vehicle tank.

6. The venting device of claim 1, wherein, in the installation position the venting inlet is located at a top region of the filling pipe, and the degassing outlet is located at a top region of the filling pipe.

7. The venting device of claim 1, further comprising a curvilinear guiding member arranged in the filling pipe to guide incoming vapor introduced via the venting inlet into the filling pipe along the circumference of the filling pipe between an inner wall of the filling pipe and the curvilinear guiding member so that a gaseous portion of the incoming vapor is discharged through the degassing outlet and a liquid portion of the incoming vapor flows away through the filling pipe.

8. The venting device of claim 7, wherein the curvilinear guiding member comprises a plurality of ribs on an outer wall thereof facing an inner wall of the filling pipe in order to separate liquid.

9. The venting device of claim 7, wherein the curvilinear guiding member has a substantially U-shaped cross-section or a substantially O-shaped cross-section.

10. The venting device of claim 7, wherein the curvilinear guiding member is constructed on the connection nipple.

11. A venting device, comprising:
a filling pipe;
a venting line for fluidic connection at a first venting line end to a motor vehicle tank, and at a second venting line end to the filling pipe;
a venting inlet to fludicially connect the second venting line end to the filling pipe;
a liquid separator to separate liquid that flows through the venting line;
a degassing line for fluidic connection at a first degassing line end to the filling pipe, and at a second degassing line end to the liquid separator;
a degassing outlet to fludicially connect the first degassing line end to the filling pipe; and
a connection nipple arranged on the filling pipe upon which the venting inlet and the degassing outlet are constructed.

12. The venting device of claim 11, further comprising:
a second venting line to fluidically connect the motor vehicle tank directly to the liquid separator; and
a second degassing line to fluidically connect the liquid separator to a fuel vapor filter.

13. The venting device of claim 11, further comprising a valve arranged in the filling pipe at the degassing outlet, the valve being moveable in a closing direction in response to introduction of a filling nozzle into the filling pipe, to thereby reduce or close the degassing outlet during refueling of the motor vehicle tank.

14. The venting device of claim 11, wherein, in the installation position the venting inlet is located at a top region of the filling pipe, and the degassing outlet is located at a top region of the filling pipe.

15. The venting device of claim 11, further comprising a curvilinear guiding member arranged in the filling pipe to guide incoming vapor introduced via the venting inlet into the filling pipe along the circumference of the filling pipe between an inner wall of the filling pipe and the curvilinear guiding member so that a gaseous portion of the incoming vapor is discharged through the degassing outlet and a liquid portion of the incoming vapor flows away through the filling pipe.

16. The venting device of claim 15, wherein the curvilinear guiding member comprises a plurality of ribs on an outer wall thereof facing an inner wall of the filling pipe in order to separate liquid.

17. The venting device of claim 15, wherein the curvilinear guiding member has a substantially U-shaped cross-section.

18. The venting device of claim 15, wherein the curvilinear guiding member has a substantially O-shaped cross-section.

19. The venting device of claim 15, wherein the curvilinear guiding member is constructed on the connection nipple.

20. A venting device, comprising:
a filling pipe;
a first venting line for fluidic connection at a first venting line end to a motor vehicle tank, and at a second venting line end to the filling pipe;
a venting inlet to fludicially connect the second venting line end to the filling pipe;
a liquid separator to separate liquid that flows through the venting line;
a first degassing line for fluidic connection at a first degassing line end to the filling pipe, and at a second degassing line end to the liquid separator;
a degassing outlet to fludicially connect the first degassing line end to the filling pipe;
a connection nipple arranged on the filling pipe upon which the venting inlet and the degassing outlet are constructed; and
a curvilinear guiding member arranged in the filling pipe to guide incoming vapor introduced via the venting inlet into the filling pipe along the circumference of the filling pipe between an inner wall of the filling pipe and the curvilinear guiding member so that a gaseous portion of the incoming vapor is discharged through the degassing outlet and a liquid portion of the incoming vapor flows away through the filling pipe.
